(19) United States
(12) Patent Application Publication
(10) Pub. No.: US 2003/0150746 A1
(43) Pub. Date: Aug. 14, 2003

(54) Apparatus and method for maintaining hydration and integrity of water-based substances during use, storage, and transport

(76) Inventor: Celeste Mendelsohn, Monrovia, CA (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/074,448

(22) Filed: Feb. 12, 2002

(51) Int. Cl. B44D 3/00; B05C 17/00

(52) U.S. Cl. 206/1.7

(57) ABSTRACT

A hydrating paint box and palette system for using, storing, and transporting paints or other water-based substances is disclosed. The paint box (10) contains a plurality of wells (30), each with a cover (28) that limits exposure to air and reduces evaporation, preventing the contents of the wells (30) from drying out. The wells (30) contain a sponge (34) that when moistened with water provides a hydrating mechanism creating a moist environment for storing water-based substances such as acrylic paints. The substances can be used directly from the well (30) and can be transported conveniently without contaminating each other.

### FIELD OF THE INVENTION

The present invention relates in general to a storage and transport apparatus and method for substances such as paint or glue and, more particularly, to an apparatus and method that maintains the substances in a moist, workable condition while providing for transport of several substances without compromising the integrity of the individual substances.

### BACKGROUND OF THE INVENTION

Water-based paints, such as acrylic-type paints, are water-based emulsions. Therefore, when acrylic-type paints are exposed to air, the paints dry out. When acrylic-type paints dry, the paints are insoluble and cannot be reconstituted to a useable condition. For example, when brushes coated with acrylic paints dry before the paint has been removed, the brushes become permanently damaged and must be discarded.

Paint palettes are platforms on which dabs of paint are placed. Palettes are also used to mix paints and to remove excess paint from a paintbrush before applying the paint to the desired surface. Traditionally, palettes have not been designed to provide for hydration of paints during use or storage.

On traditional palettes, only small quantities of mixtures that would be used immediately could be created. Mixing large quantities results in wasted paint that dried out before being used. The ability to mix only small quantities results in extra time and effort spent continually remixing small quantities, as well as creating inconsistencies in color from one time to the next. Furthermore, newly created colors can not be saved for use at another time.

The principal prior attempts at maintaining hydrated paints use a palette system consisting of a single moistened sponge layer covered by a continuous sheet of porous material on which the paints are placed. The layers are placed in a box that can be covered for storage.

Palettes designed in this manner have several disadvantages. Since the paints are contained on one continuous sheet, the palette must be stored and transported horizontally at all times to prevent the paints from running together and contaminating each other. Additionally, if the palette is not maintained in a horizontal position, water in the sponge layer may drain to lower areas of the palette, causing the higher sections to dry out. Therefore, storing and transporting such a palette becomes arduous because the palette cannot be tipped or carried in a vertical manner.

Even when the palette is used in a horizontal manner, color contamination may still occur. Since all the paints are placed on one continuous sheet, running and undesired mixing are difficult to prevent. For example, whites are often contaminated. Once the porous sheet has been used for dark colors, both the porous layer and the sponge layer must be replaced or cleaned before using light colors, in order to avoid contamination. Replacing both layers requires additional expense, not only in purchasing both replacement layers, but also in paint remaining on the previous porous sheet that may be wasted in the replacement. Furthermore, in order to clean the palette, both layers must be removed and cleaned, resulting in additional time spent cleaning and additional expense in wasting other paints still remaining on portions of the porous sheet layer.

The current hydrating palette designs are also not conducive to using, storing, or transporting a heterogeneous array of substances. Hydrating palettes can also be used for other water-soluble substances, such as water-based glue. However, the difficulty in keeping substances separated, due to having a single continuous sheet, makes storing and transporting paint and glue on the same palette difficult.

Additionally, since the palette cover must be removed in one piece exposing the entire porous sheet to the air, extended exposure to the air or failure to replenish the sponge with water, will result in every paint or substance on the palette drying out. Thus, the entire contents of the palette are lost, which increases replacement costs.

Furthermore, since the palette surface itself is a thin porous sheet, the palette is not conducive to use in combination with a painter's knife, or palette knife, in applying, mixing or removing paint. The knife tears the porous sheet and paint is lost through the tear into the sponge layer. Tearing results in further cross-contamination due to paint soaking into the sponge layer and additional expense in replacing torn porous sheets and lost paint. Finally, current hydrating palette designs do not provide for storage and transport of other painting supplies such as a hard palette surface or paintbrushes.

### BRIEF DESCRIPTION OF THE DRAWINGS

FIG. 1 is a three-dimensional view of a paint storage and transport apparatus;

FIG. 2 is a top view of the paint storage and transport apparatus, with the palette lid removed;

FIG. 3 is a cross-sectional view of one row of wells of a plurality of rows formed in the paint storage and transport apparatus; and

FIG. 4 is a cross-sectional view of one row of wells of a plurality of rows formed in an alternative embodiment of the paint storage and transport apparatus.

### DETAILED DESCRIPTION OF THE DRAWINGS

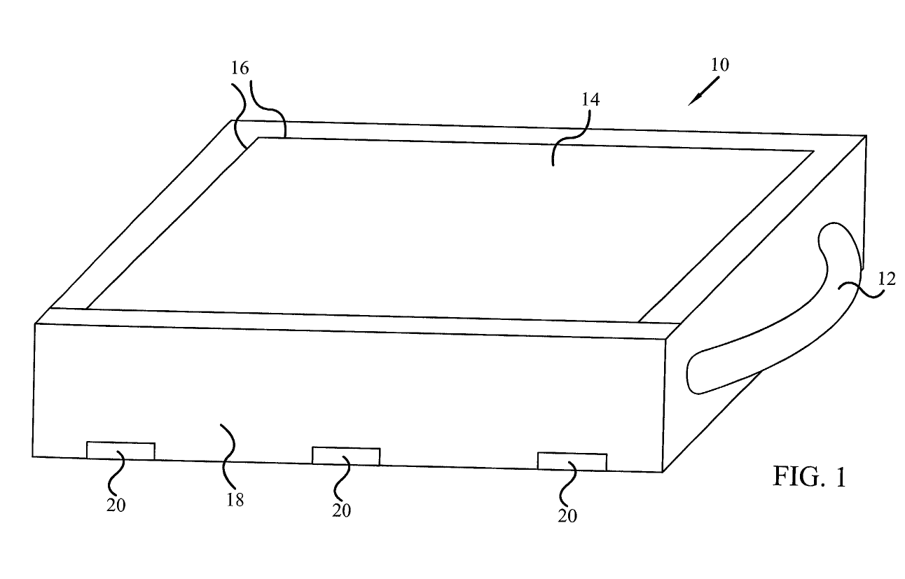

FIG. 1 shows a paint storage and transport apparatus (paint box) 10. Paint box 10 comprises a three-dimensional rectangular box with a handle 12 and a palette lid 14. Paint box 10 is 35.0 cm in length by 25.0 cm in width by 5.0 cm in height. Paint box 10 may also be a variety of other shapes and sizes.

Handle 12 is 15.0 cm in length and has a thickness of 1.5 cm with a sufficient gap between the side of paint box 10 and handle 12 to allow a human hand to grasp handle 12. Paint box 10 and handle 12 are made of wood, metal, plastic, polymer, or other synthetic material.

Paint box 10 also has palette grooves formed under top lip 16. Palette lid 14 slides into the palette grooves to cover paint box 10. Top lip 16 projects 1.0 cm over palette lid 14 on both width sides and the length side opposite the latch side 18. Latch side 18 closes to form the second length side of paint box 10. When latch side 18 is closed, latch side 18 forms a lip, projecting 1.0 cm over palette lid 14, preventing palette lid 14 from sliding out of place. The palette grooves hold palette lid 14 in place when latch side 18 is closed. Alternative embodiments of palette lid 14 are also envisioned, including holding palette lid 14 in place with detachable hinges.

Latch side 18 is hinged in three places by exterior hinges 20. Exterior hinges 20 are each 3.0 cm in length. Exterior hinges 20 are flexible plastic hinges, allowing latch side 18 to open for removal of palette lid 14.

Palette lid 14 is a hard palette removable from paint box 10. Palette lid 14 is used as a hard surface to mix paints or place paints on during use. Palette lid 14 also provides a surface to remove excess quantities of paint from a paintbrush. Palette lid 14 may also have a thumb hole or other type of handle to hold the palette while painting. Palette lid 14 provides a lid for paint box 10, while conveniently supplying a hard palette in the same box as the paint and other art supplies.

Palette lid 14 is made of polycarbonate, or specifically polycarbonate of bisphenol A, a clear plastic used to make shatterproof windows, lightweight eyeglass lenses, and such. Using a clear polycarbonate plastic for palette lid 14 allows the contents of paint box 10 to be visible without removing palette lid 14. Palette lid 14 also does not shatter if dropped. Furthermore, palette lid 14 resists scratching from palette knives when mixing paints. Finally, palette lid 14 resists staining from paints and is easily cleaned of excess or unwanted paints.

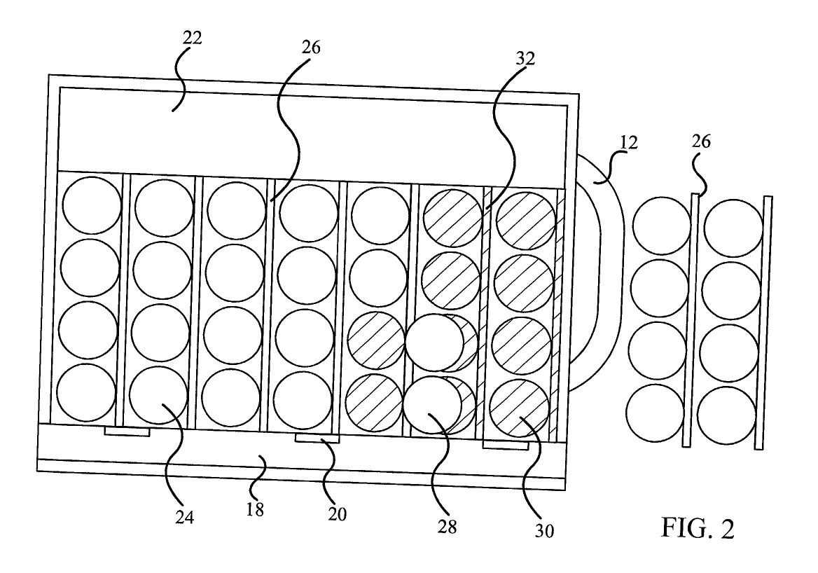

FIG. 2 shows the top view of paint box 10 with latch side 18 open and palette lid 14 removed. Paint box 10 comprises a plurality of containers 24, each comprised of a well 30 and a cover 28. Paint box 10 contains twenty-eight containers 24, arranged in seven rows with four containers 24 in each row. Various quantities and arrangements of containers 24 are also envisioned.

Four covers 28 are connected to a hinge pin 26. Covers 28 are attached to hinge pin 26 via a flexible plastic hinge, so that covers 28 can be each individually opened and closed over wells 30 while attached to hinge pin 26. Hinge pin 26 is a plastic rod, 15.5 cm in length and 0.25 cm in diameter.

Hinge pin 26 snaps into hinge groove 32 to hold covers 28 in place. Hinge groove 32 is 15.5 cm in length and formed as a groove 0.25 cm deep in the top face of paint box 10. Seven hinge grooves 32 are formed between each row of wells 30, providing for seven hinge pins 26, each with four covers 28 attached, allowing all twenty-eight wells 30 to be covered with covers 28.

Connecting covers 28 to hinge pins 26 in this manner allows for easy removal of covers 28 from wells 30. Covers 28 can be opened individually, while hinge pin 26 is snapped into hinge groove 32, exposing only one well 30 at a time without completely removing covers 28, thereby preventing individual covers 28 from becoming misplaced. However, if it is desirable to expose several wells 30 at one time, covers 28 can be completely removed from paint box 10 by removing hinge pin 26 from hinge groove 32, yet covers 28 will continue to remain attached to hinge pin 26, making removal convenient and also preventing individual covers 28 from becoming misplaced. The same objective may be accomplished with alternative embodiments of the covers 28. For example, the covers 28 may be attached as a single sheet of covers 28, either removable altogether as one sheet, or opened individually.

Paint box 10 also contains storage tray 22. Storage tray 22 is 33.0 cm in length by 10.0 cm in width and 3.0 cm deep. Storage tray 22 provides a storage area for paintbrushes, palette knives, and other art supplies. Storage tray 22 allows an artist's tools to be conveniently stored and transported in the same box as the paint. Storage tray 22 is also used to store covers 28 attached to hinge pin 26, when hinge pins 26 are snapped out and removed completely from hinge grooves 32.

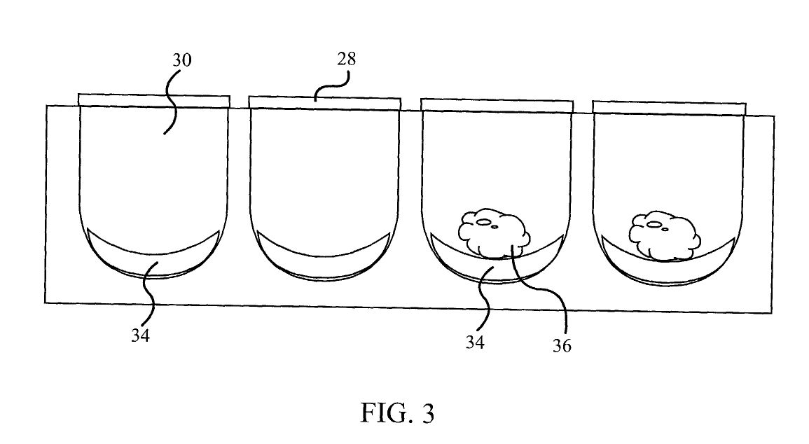

FIG. 3 is a cross-sectional view of one row of containers 24 with covers 28 closed. Covers 28 are plastic lids that snap closed into and over well 30. Covers 28 are 3.0 cm in diameter. When closed, covers 28 set 0.25 cm into well 30, and project 0.25 cm above the top surface of paint box 10. When closed, covers 28 limit contents of well 30 from exposure to air, reducing evaporation, thus preventing the contents of well 30 from drying out. Covers 28 also keep the individual substances in wells 30 self-contained. Therefore, paint box 10 can be conveniently carried with handle 12 in a vertical manner, much like a briefcase, without the individual substances in wells 30 contaminating each other.

Wells 30 are circular wells formed in the plastic in the top face of paint box 10. Each well 30 is 3.0 cm in diameter at the surface and 3.0 cm deep. Wells 30 are tapered and rounded at the bottom. Wells 30 are also envisioned as a variety of shapes and sizes, including, but not limited to, cylindrical, cubed, or triangular.

Well 30 contains a sponge 34. Sponge 34 is a circular foam sponge 2.0 cm in diameter and 0.5 cm thick. Sponge 34 can also be comprised of other plastic sponge material, other synthetic material, wood fiber, or organic sponge. Sponge 34 rests in the bottom of well 30.

A solvent, in the particular case of water-based substances such as acrylic paints, water, is added to sponge 34 to create a moist environment inside container 24. After water is added to sufficiently moisten sponge 34, paint 36 is placed on the sponge. Sponge 34 keeps paint 36 moist and hydrated. When cover 28 is open during use of paint 36, sponge 34 keeps the paint moist and prevents paint 36 from drying out. With cover 28 closed, container 24 with sponge 34 maintains the hydration of paint 36 during storage and transport. Other solvents, depending on the nature of the substance to be stored and transported, may also be applied to sponge 34 to maintain the substance in a usable or pliable state.

Applying paint 36 directly to sponge 34, rather than an intermediate layer, provides for direct hydration. Therefore, vertical transport and storage of paint box 10 does not result in the drainage and drying-out problems caused by vertical transport of prior hydrating palettes. Both the small contained area of well 30 and the direct contact of paint 36 with sponge 34 provide continuous hydration of paint 36 during vertical transport and storage.

Sponge 34 serves as both a hydrating mechanism and a palette. Paint 36 can be used directly from sponge 34 and applied to the desired surface. Sponge 34 acts as a palette by providing a surface for applying paint 36 to a paintbrush and for removing excess paint 36 from the paintbrush. Additionally, sponge 34 acts as a palette by providing a surface to mix paints to create a desired color.

Furthermore, since paint 36 is placed directly on sponge 34, vertical transport does not result in paint 36 drying-out. Even if sponge 34 slides to the side of container 24, paint 36 maintains direct contact with sponge 34. Therefore, paint 36 continues to be hydrated even when paint box 10 is in the vertical position.

Since container 24 keeps paint 36 hydrated, large quantities of paint can be mixed at one time. Newly created colors can then be stored for use at later time. Since large quantities of paint can be mixed and stored, color consistency is maintained over time. Furthermore, repeated mixing of small quantities is not required, saving time, and labor.

Each container 24 holds a single color of paint. Since paint box 10 is comprised of a plurality of containers 24, many different colors can be stored and transported. Containers 24 can also be used to keep other water-based substances, such as glue, hydrated. Each color or substance is self-contained in an individual container 24. Therefore, multiple colors and multiple substances can be stored and transported without compromising the integrity of the individual colors or individual substances. Vertical transport of paint box 10 does not result in individual substances mixing and losing their integrity, thus allowing convenient transport and storage of paint box 10.

Additionally, if container 24 needs to be used for a different color or different substance, only one sponge 34 needs to be replaced or cleaned, not the entire layered sponge and porous sheet, reducing cost and labor involved. Also, applying paint 36 directly to sponge 34 eliminates the need for an additional thin porous layer, reducing cost. Finally, sponge 34 is more durable than a thin porous layer and will withstand use of a palette knife to apply and mix paint on sponge 34.

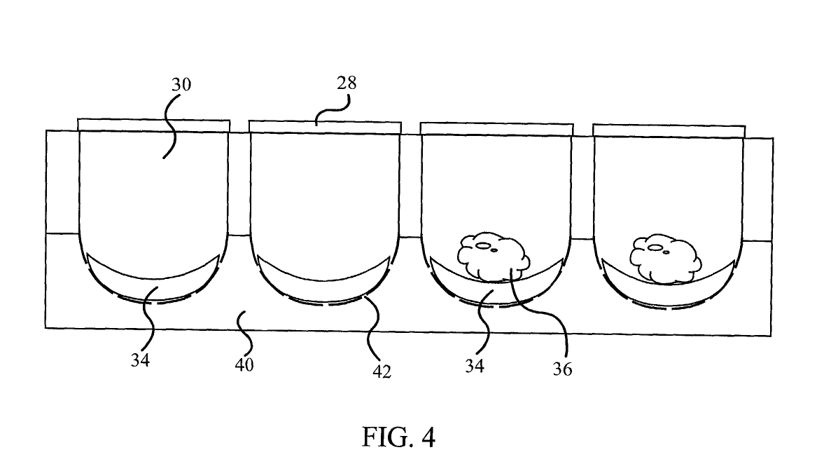

Turning to FIG. 4, paint box 10 may, alternatively, contain a reservoir 40 underneath wells 30. Reservoir 40 contains solvent, such as water, which is absorbed by sponge 34 through openings 42 in the bottom of well 30. Reservoir 40 is filled with solvent through a hole on the side of paint box 10, then plugged with a rubber plug to contain the solvent in reservoir 40. Here, well 30, may or may not contain sponge 34. Sponge 34 may also reside in reservoir 40 beneath well 30, yet adjacent to well 30 at openings 42, providing solvent to well 30 through openings 42.

Another alternative embodiment envisions cover 28 containing reservoir 40. Reservoir 40 in cover 28 may or may not contain sponge 34. Openings 42 are then present in the portion of cover 28 adjacent to well 30. Cover 28 hydrates well 30 from reservoir 40 in cover 28, rather than from reservoir 40 below well 30.

The paint storage box and palette described above provides a convenient tool and method for using, storing, and vertically transporting paints and other water-based substances. Hydration of paints and other substances is maintained at all times, preventing the paints from drying out, becoming unusable and needing to be discarded. Additionally, integrity of individual paints and substances is maintained through the use of a system of a plurality of separate wells with well covers and individual sponges keeping the substances self-contained and hydrated. Finally, the storage tray and hard palette lid provide for convenient transport of an artist's other tools in the same container as the paints and glues.

Although the present invention has been described with respect to preferred embodiments, any person skilled in the art will recognize that changes may be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the appended claims.

What is claimed is:

1. A paint storage and transport apparatus, comprising:
a support structure having a plurality of wells in the support structure;
a sponge disposed within a first well of the plurality of wells; and
a cover for the first well of the plurality of wells.

2. The paint storage and transport apparatus of claim 1, wherein the plurality of wells are formed in the support structure.

3. The paint storage and transport apparatus of claim 1, further including a reservoir disposed adjacent to the plurality of wells.

4. The paint storage and transport apparatus of claim 3, further including a first opening between the reservoir and the first well of the plurality of wells.

5. The paint storage and transport apparatus of claim 3, wherein the reservoir disposed adjacent to the plurality of wells is in the cover for the first well of the plurality of wells.

6. The paint storage and transport apparatus of claim 1, wherein the sponge is adapted for containing solvent.

7. The paint storage and transport apparatus of claim 6, wherein the solvent is water.

8. The paint storage and transport apparatus of claim 1, wherein the sponge is adapted for providing hydration of the first well of the plurality of wells.

9. The paint storage and transport apparatus of claim 1, wherein the cover for the first well of the plurality of wells is attached to a hinge pin.

10. The paint storage and transport apparatus of claim 9, further including a hinge groove in the support structure for attaching the hinge pin.

11. The paint storage and transport apparatus of claim 1, further including a palette lid for covering the support structure.

12. The paint storage and transport apparatus of claim 11, further including palette grooves to hold the palette lid on the support structure.

13. The paint storage and transport apparatus of claim 1, further including a storage tray in the support structure.

14. A paint storage and transport apparatus, comprising:
a support structure having a plurality of wells in the support structure;
a reservoir, disposed adjacent to a first well of the plurality of wells;
a first opening between the reservoir and the first well of the plurality of wells; and
a cover for the first well of the plurality of wells.

15. The paint storage and transport apparatus of claim 14, wherein the plurality of wells are formed in the support structure.

16. The paint storage and transport apparatus of claim 14, wherein the reservoir disposed adjacent to the first well of the plurality of wells is in the cover for the first well of the plurality of wells.

17. The paint storage and transport apparatus of claim 14, further including a sponge disposed within the first well of the plurality of wells.

18. The paint storage and transport apparatus of claim 14, further including a sponge disposed within the reservoir.

19. The paint storage and transport apparatus of claim 14, further including a sponge disposed within the cover.

20. The paint storage and transport apparatus of claim 14, wherein the reservoir is adapted for containing solvent.

21. The paint storage and transport apparatus of claim 14, wherein the reservoir is adapted for providing hydration of the first well of the plurality of wells.

22. A method of manufacturing a paint storage and transport apparatus, comprising:
disposing a plurality of wells in a support structure;
providing a sponge adapted to be disposed within a first well of the plurality of wells; and
providing a cover for the first well of the plurality of wells.

23. A method of manufacturing a paint storage and transport apparatus in claim 22, further including providing a reservoir adapted to be disposed adjacent to a second well of the plurality of wells.

24. A method of manufacturing a paint storage and transport apparatus in claim 23, further including making a first opening between the second well of the plurality of wells and the reservoir.

25. A method of manufacturing a paint storage and transport apparatus in claim 23, further including providing the reservoir adapted to be disposed adjacent to the second well of the plurality of wells in the cover for the second well of the plurality of wells.

26. A method of manufacturing a paint storage and transport apparatus in claim 22, further including attaching the cover for the first well of the plurality of wells to a hinge pin.

27. A method of manufacturing a paint storage and transport apparatus in claim 26, further including providing a hinge groove in the support structure for attaching the hinge pin.

28. A method of manufacturing a paint storage and transport apparatus, comprising:
disposing a plurality of wells in a support structure;
providing a reservoir, adapted to be disposed adjacent to a first well of the plurality of wells;
making a first opening between the reservoir and the first well of the plurality of wells; and
providing a cover for the first well of the plurality of wells.

29. A method of manufacturing a paint storage and transport apparatus in claim 28, wherein the reservoir adapted to be disposed adjacent to the first well of the plurality of wells is provided in the cover for the first well of the plurality of wells.

30. A method of manufacturing a paint storage and transport apparatus in claim 28, further including providing a sponge adapted to be disposed within the first well of the plurality of wells.

31. A method of manufacturing a paint storage and transport apparatus in claim 28, further including providing a sponge adapted to be disposed within the reservoir.
